(19) United States
(12) Patent Application Publication
(10) Pub. No.: US 2003/0074291 A1
(43) Pub. Date: Apr. 17, 2003

(54) Integrated program for team-based project evaluation

(76) Inventors: Christine Hartung, Jena (DE); Wilhelm Ott, Dreieich (DE); Sandra Schwebke, Griesheim (DE)

Correspondence Address: OLSON & HIERL, LTD., 36th Floor, 20 North Wacker Drive, Chicago, IL, 60606, US

(21) Appl. No.: 10/247,384

(22) Filed: Sep. 19, 2002

Related U.S. Application Data
(60) Provisional application No. 60/323,282, filed on Sep. 19, 2001.

(51) Int. Cl. G06F 17/60

(52) U.S. Cl. 705/35

(57) ABSTRACT

A computer-assisted method for evaluating a product development project comprises interactively defining a plurality of development scenario models, interactively assigning a probability to each of the plurality of development scenarios to produce a plurality of corresponding probabilities, calculating a net present value for each of the development scenario models to produce a plurality of corresponding net present values, and processing the probabilities and the net present values to calculate a probability-weighted net present value for the development project. The step of defining a plurality of development scenario models includes modeling cost-generating activities and income-generating activities.

### CROSS-REFERENCE TO RELATED APPLICATION

This application claims the benefit of the filing date of U.S. Provisional Patent Application, Serial No. 60/323,282, filed on Sep. 19, 2001, the contents of which are incorporated herein by reference.

### TECHNICAL FIELD

This invention relates to computer software systems and methods for evaluating development projects, and in particular, software systems and methods for evaluating pharmaceutical development projects.

### BACKGROUND

Companies engaged in higher risk product development have long sought the ability to predict the relative value of pending and prospective projects. Given the challenge of funding multiple high-risk projects and selecting among alternative research paths, pharmaceutical companies, in particular, seek better mechanisms to cope with this financial uncertainty.

Planners thus far have used software spreadsheets to predict project costs and possible benefits. The conventional spreadsheet creation process is expensive and time-consuming to implement, however. The spreadsheets have been both project and author specific. Because such project spreadsheets are specially prepared, the spreadsheets' original authors are continually needed to control data entry or change basic assumptions.

The complex nature of the resulting spreadsheet tables hinders the direct participation of non-authors in the project modeling process. For example, an expert on product sales and marketing costs will not directly change data or assumptions in a complex spreadsheet. Accordingly, product development valuation is left to experts too often; the modeling process being viewed as a specialized discipline rather than as an important tool for running the business. This limits, in practice, the variety of options considered and the quality of the knowledge employed. The marginalization of value creation and the complex tools usually used lead to a “black box” experience and widespread skepticism about the results.

Collaboration in the prediction process is also hindered by the conventional approach to soliciting input from others. The prediction spreadsheets are usually exchanged as e-mail attachments. This not only extends the time needed for project evaluation but is also a source of mistakes when different versions of the spreadsheet file are maintained in parallel.

There is no known calculation method or tool in the prior art available that allows for an integrated, practical and fast calculation technique using a well coordinated calculation model that enables users to benchmark competing projects among one another.

### SUMMARY

The present invention fills this deficiency in the prior art by providing a computer-assisted method for evaluating a development project that comprises interactively defining a plurality of development scenario models, interactively assigning a probability to each of the plurality of development scenarios to produce a plurality of corresponding probabilities, calculating a net present value for each of the development scenario models to produce a plurality of corresponding net present values, and processing the plurality of probabilities and the plurality of net present values to calculate a probability-weighted net present value for the development project. The step of defining a plurality of development scenario models preferably includes modeling cost-generating activities and income-generating activities.

The net present value (NPV) calculation and the analyses of development risks are combined in the project model in order to determine the expected project NPV, which is defined as the sum of probability-weighted scenario NPVs. The resulting single number represents the financial value of the development project, including its risks.

Another aspect of the present invention provides a method for financially modeling a development project incorporating information from different contributors. The multi-contributor method includes defining a financial model for the development project as a plurality of activity segment submodels, generating a set of required inputs for each of at least two activity segment submodels, providing access to the sets of required inputs over a computer network, receiving information according to one of the sets of required inputs from a first contributor, and receiving information according to another of the sets of required inputs from another contributor.

### BRIEF DESCRIPTION OF THE FIGURES

In the accompanying drawings that form part of the specification, and in which like numerals are employed to designate like parts throughout the same,

FIG. 1 is a schematic diagram illustrating a probability-weight net present value calculation according to the present invention;

FIG. 2 is a block diagram illustrating aspects of project modeling and net present value calculation according to the present invention;

FIG. 3 is a simplified flowchart of steps for specifying the basic structure of scenario models;

FIG. 4 is a block diagram of an exemplary first scenario structural definition;

FIG. 5 is a block diagram of an exemplary third scenario structural definition;

FIG. 6 is an exemplary user display for a scenario structural definition including a detailed specification of research and development phases;

FIG. 7 is a block diagram illustrating the specification of different activity category submodels by different contributors via a computer network;

FIG. 8 is a simplified flowchart of a user interface sequence for entering research and development cost estimate data;

FIG. 9 is a simplified flowchart of a user interface sequence for entering predicted sales data and equations;

FIG. 10 is an exemplary user display for selecting territories for sales forecasting;

FIG. 11 is a simplified flowchart of a user interface sequence for entering marketing and sales-related costs;

FIG. 12 is a simplified flowchart of a user interface sequence for entering prospective and established licensing partner cost and income related estimates;

FIG. 13 is a simplified flowchart of a user interface sequence for entering estimates for the required project investments;

FIG. 14 is a simplified flowchart of a user interface sequence for entering operating and production cost estimates;

FIG. 15 is a simplified flowchart of a user interface sequence for review and approval of data and equation inputs;

FIG. 16 is a block diagram illustrating exemplary calculated outputs available from project evaluation systems according to the present invention; and

FIG. 17 is a block diagram illustrating key features of the project evaluation method according to the present invention.

### DETAILED DESCRIPTION OF PREFERRED EMBODIMENTS

While this invention is susceptible to embodiment in many different forms, this specification and the accompanying drawings disclose only preferred forms as examples of the invention. The invention is not intended to be limited to the embodiments so described, however. The scope of the invention is identified in the appended claims.

In the FIGURES, a single block or cell may indicate several individual software components that collectively perform the identified single function. Likewise, a single line may represent several instances of software data sharing or interconnection.

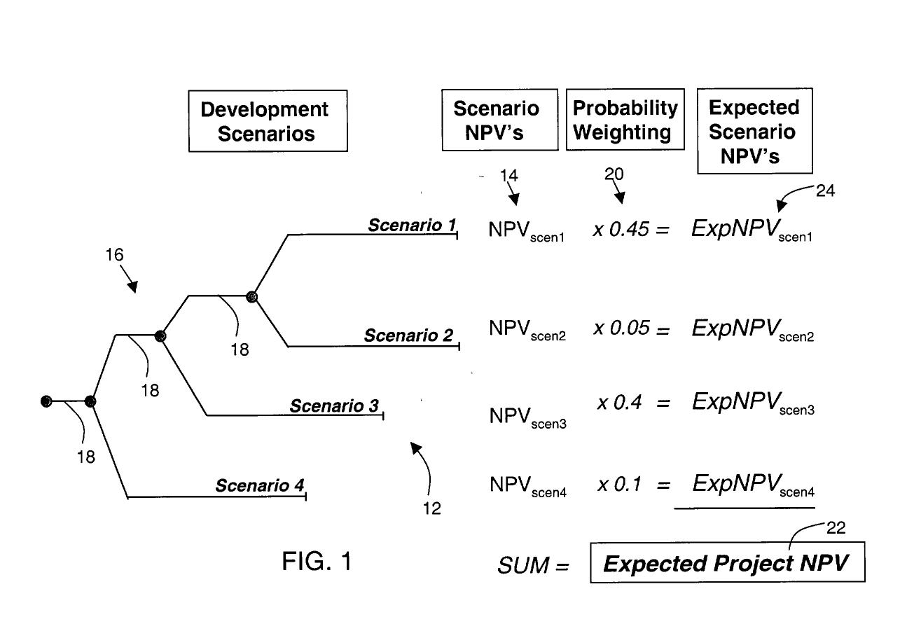

FIG. 1 is a symbolic representation of a development project evaluation method according to the present invention. A plurality of scenario models 12 are defined for calculating a corresponding set of net present values (NPVs) 14 for a pharmaceutical development project. As illustrated, the plurality of project scenario models 12 are preferably interrelated as branches on a decision tree 16 such that the scenarios generally share certain phases of activity 18 (or activity segments).

Each scenario model 12 is assigned a probability factor 20. To calculate a probability-weighted average net present value 22 for the overall development project, each scenario NPV 14 is first multiplied by the corresponding probability factor 20 to generate a set of intermediate values, labeled “expected scenario NPVs” and identified in FIG. 1 with reference number 24. The expected scenario NPVs 24 are then summed to arrive at a probability-weighted net present value 22.

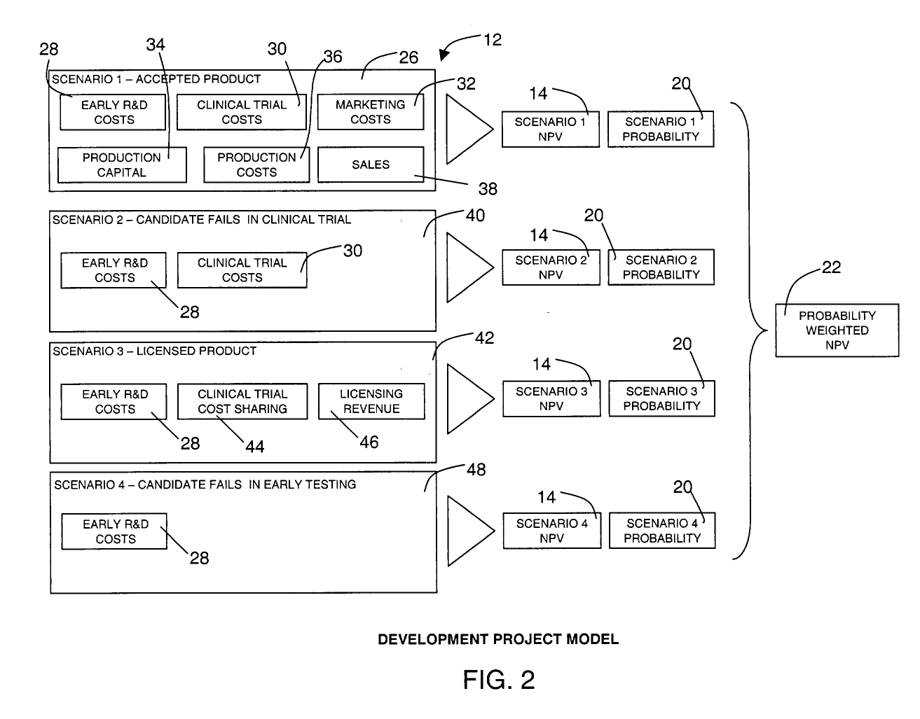

FIG. 2 offers additional details on the scenario modeling aspects of the present invention. Each development scenario model 12 is subdivided into one or more activity categories, e.g. clinical trial cost. The activity categories represent submodels or groups of estimations for individual project phases or project subjects. For example, development scenario Model One 26 provides cash-flow, NPV and various other calculations for a scenario resulting in a pharmaceutical product approved for sale. Scenario Model One 26 has the following six activity categories: early research and development (R&D) costs 28, clinical trial costs 30, marketing costs 32, production capital expenses 34, product cost 36 and projected sales 38.

Development scenario Model Two 40 is defined to represent a pharmaceutical candidate failing in clinical trials. Model One 26 and Model Two 40 share the same early R&D costs category 28 and the same clinical trial cost category 30.

Development scenario Model Three 42 includes financial calculations for a scenario resulting in licensed technology. Scenario Model Three 42 has the following three activity categories early R&D costs 28, clinical trial cost sharing 44 and licensing revenue 46. Model Three 42 has the same early R&D category 28 as both Model One 26 and Model Two 40.

Scenario Model Four 48 covers the case in which the pharmaceutical candidate (or group of candidates) fails in early testing. Scenario Model Four 48 shares the early R&D cost category 28 with the other three scenario models 26, 40 and 42.

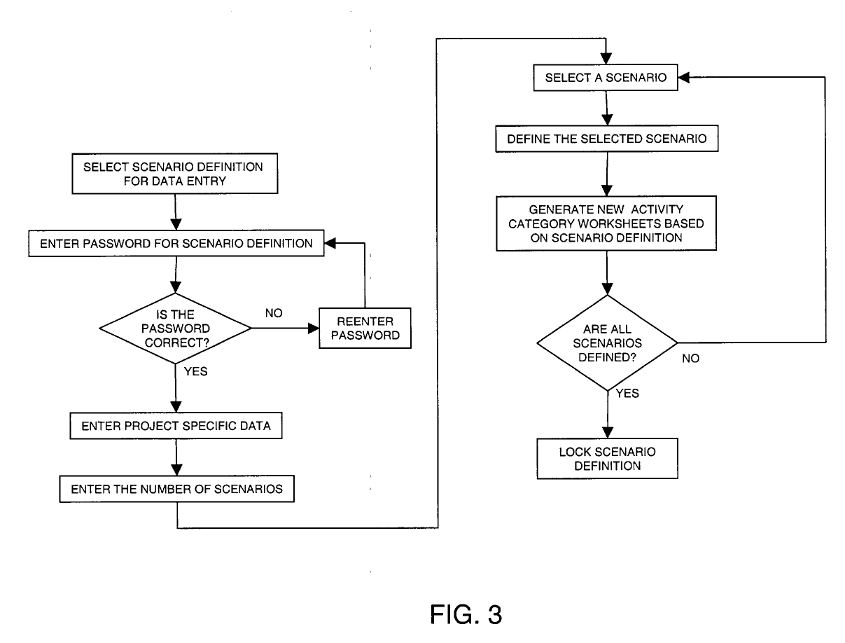

The flowchart in FIG. 3 describes an exemplary user interface sequence for specifying the basic structure of scenario models. The project evaluation method is preferably implemented via a network-accessible software system that first calls for a project planner to define the scope of the development project in terms of the number and type of different scenarios, and also to specify the probability factor 20 for each scenario. This main project definition is preferably restricted to a limited number of users by password protection.

Development models according to the present invention can therefore be utilized for evaluation as a project progresses. The project definitions, including the number of scenarios and their respective probabilities 20, are modifiable as desired to provide for the identification of alternatives outcomes as the project progresses, or to adjust risk factors as milestones are completed. For example, if a pharmaceutical development project reaches U.S. F.D.A. Phase III clinical trials, the probability factors 20 can be adjusted to eliminate the possibility of the “fails in early testing” scenario.

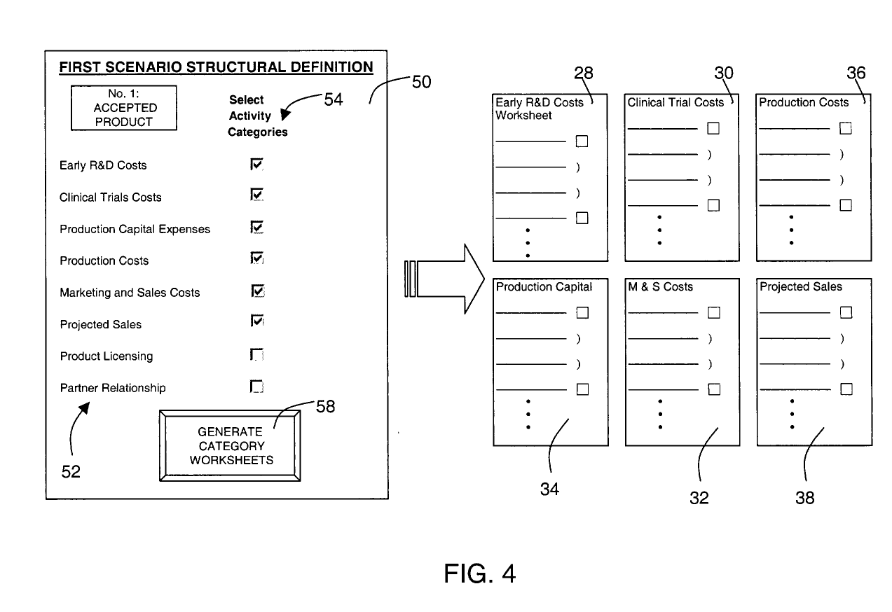

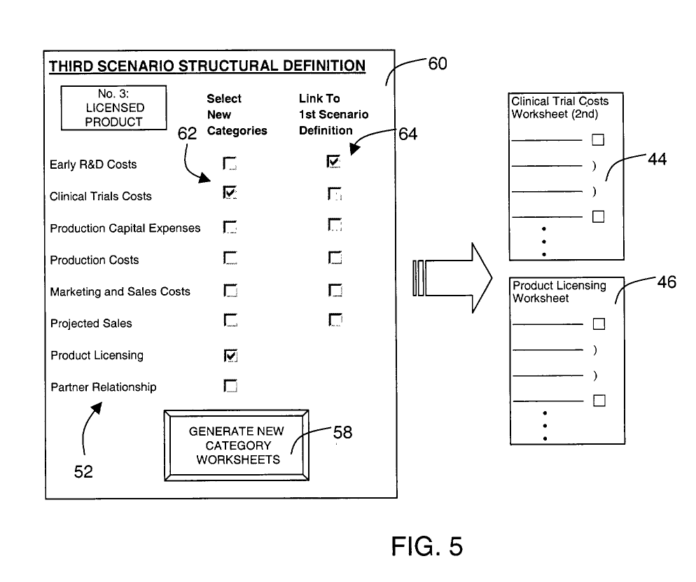

After the number of scenarios has been specified, each scenario model is defined as illustrated in FIGS. 4 and 5. FIG. 4 includes an exemplary user display 50 for defining the first, positive-outcome scenario. Display 50 includes a menu of activity categories 52 with check-mark boxes 54. After selecting the required activity categories, the planner triggers the generation of the necessary input worksheets 56, one for each category, by a software switch 58 or the like. Display 50 represents the activity category selections for scenario Model One 26 and results in the generation of six activity category worksheets as follows: early R&D costs 28, clinical trial costs 30, marketing costs 32, production capital expenses 34, production costs 36, and projected sales 38.

FIG. 5 includes a user display 60 for selecting the activity categories of a second development scenario. More specifically, the display presented in FIG. 5 corresponds to scenario Model Three 42 discussed above. Display 60 includes two columns of checkmark boxes. The first column 62 allows the project planner to select new activity categories. The second column 64 is provided to allow activity categories previously identified for scenario Model One 26 to be associated with and shared by scenario Model Three 42. Display 60 also includes a software switch 58 to trigger the generation of new activity category worksheets 44 and 46. As defined on display 60, scenario Model Three 42 requires new activity category worksheets for clinical trial costs 44 and for product licensing revenue predictions 46, but shares the early R&D costs worksheet 28 with scenario Model One 26.

Although new worksheets are preferably generated as each development scenario is defined, the applicants also contemplate a software system in which activity category worksheets are generated after category selections have been made for all scenarios.

Additionally, background information and other annotations for sales, marketing costs and partner modeling can be entered on assumption sheets. This comment information helps both portfolio managers and department experts keep track of the decisions behind the data entered.

As used herein, the term “activity category” is a reference to estimates and predictions of cash flow associated with a given category of project activity (e.g. research costs). The activity categories can also be labeled with the term “activity segment submodels.” Activity categories include fixed estimates and variablebased software submodels of the cash flow effects of a given project activity or phase. Such cash flow submodels are preferably defined in terms of variables which can be shared by multiple activity categories. For example, a time-to-market variable is shared by sales forecast submodel and a clinical-trials costing submodel.

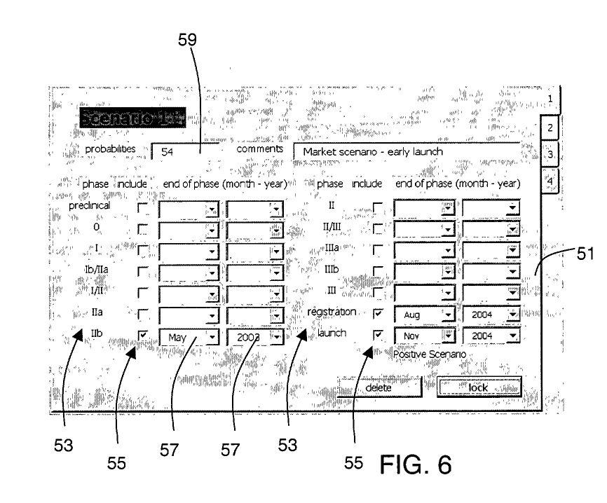

FIG. 6 is a user display 51 for scenario definition according to an alternate embodiment in which activity categories 53 are specified in greater detail by individual research and development phases. User display 51 also includes checkmark boxes 55 for selecting which activity categories, i.e. R&D phases, are applicable to the given scenario. For each activity category 53 the user can specify an end date using month and year menu fields 57. Display 51 also serves as the point of entry for assigning a probability to the scenario via probability entry field 59.

The step of completing the activity category worksheets varies in complexity. Some activity categories may require only data entry into fields on the corresponding worksheet, while the definition of other categories will require the input of equations.

Each scenario model is divided into subparts of established product-development categories. The divided structure allows the modeling process to be allocated to one or more experts in each product development category.

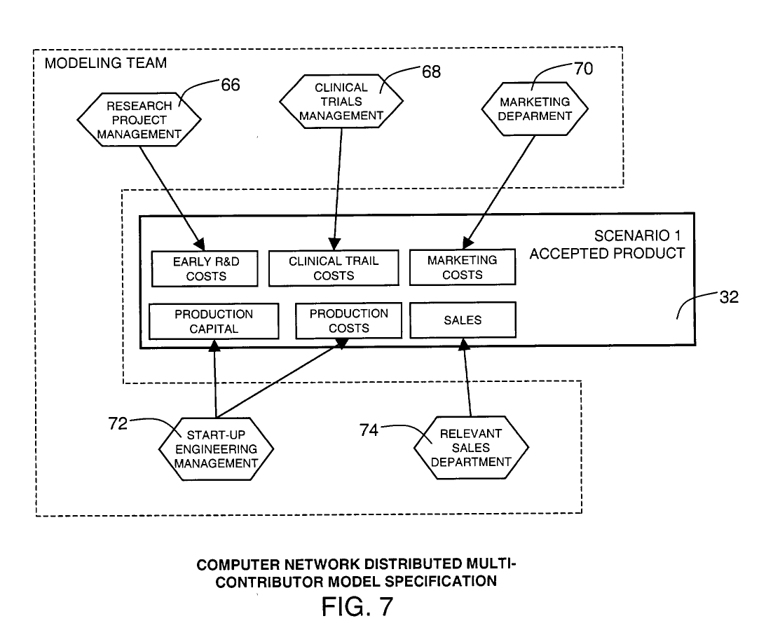

Referring now to FIG. 7, the activity category worksheets are preferably entered by experts of the related subject area working over a computer network. As depicted in FIG. 7, the team of contributors to the project model includes members from research project management 66, clinical trials management 68, marketing 70, engineering management 72 and the sales department 74.

The scenario definition menus (e.g. FIGS. 4 and 5) and activity category worksheets (e.g. R&D costs 28) are network accessible as part of a document management system. A suitable document management system is commercially available from IBM, Inc. under the designation “Lotus Notes.” The Lotus Notes document system provides selective password protection, version control, and data entry logging by user and time. The uniform and fixed structure of the integrated program allows the use of data access systems such as Lotus Notes and parallel access of all team members to the project evaluations.

Data ownership and historical follow-up is documented in order to not only create responsibility for the data input on the department level but also to allow historical analysis of the effect of changes in the project program on project value.

FIGS. 4 and 5, discussed above, include user displays generated by a user interface program to the project evaluation and modeling database. The term “program,” as used herein, refers to a software element such as an executable program, an interpreted program, a subprogram, a software process, subroutine, application macro-language routine (e.g. an Excel® macro), an application script routine, a grouping of code segments, and the like. The combination of Microsoft Excel® (Microsoft Corp.) with Visual Basic® (Microsoft Corp.) routines is presently preferred for the user interface program.

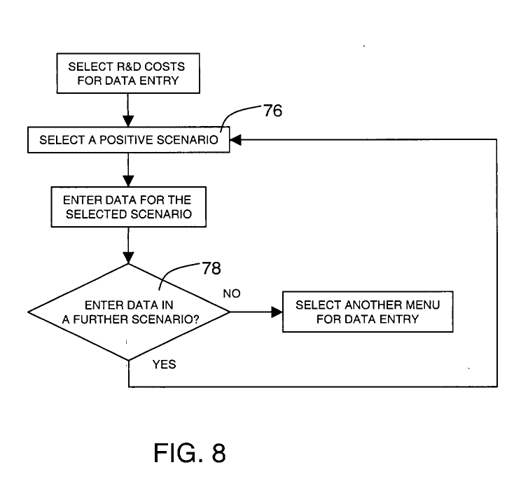

The flowchart in FIG. 8 describes an exemplary user interface sequence for entering research and development cost estimate data. A contributor first selects a positive-outcome scenario (flowchart box 76) and thereafter enters R&D cost estimate data required for the selected scenario. If different R&D cost estimate data are required for another scenario, the process is repeated (box 78). As noted above, several scenario models may share the same estimates.

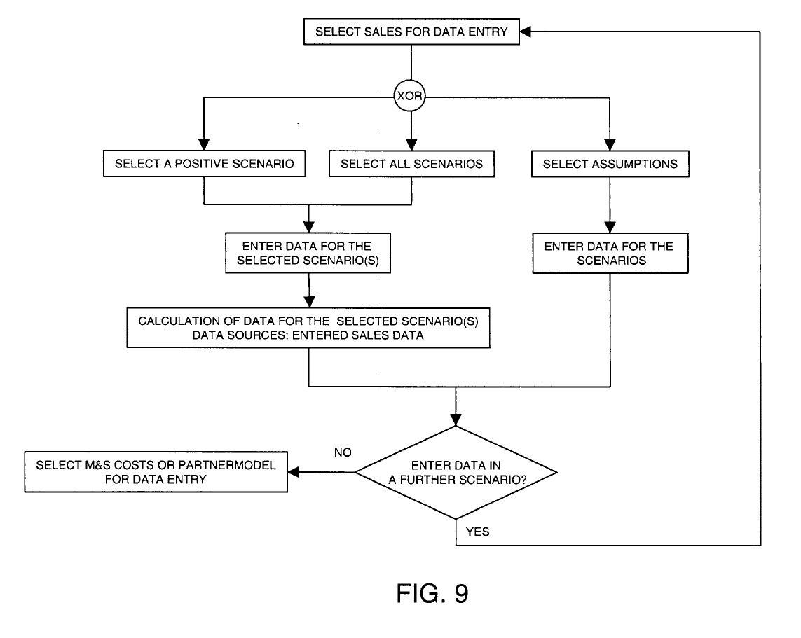

The flowchart in FIG. 9 describes an exemplary user interface sequence for entering predicted sales data and equations. For most positive-outcome scenarios, sales forecasts have to be calculated. This is preferably a task for a dedicated product manager, who has to consider market specialties like definition of the market, market segmentation and the competitive situation—today and in the future. Forecasting for the next 20 years is regarded as an especially difficult task. It is therefore helpful to increase comparability, consistency and reliability of the project evaluations. The present invention uses a common and transparent structure for the successive calculation of sales forecasts for a project that is applicable to all types of projects in all markets but is especially applicable to pharmaceutical projects on a world-wide basis.

For example, in the pharmaceutical field there are two main approaches to calculate sales—one based on patient number (epidemiological basis) and one based on market data (value basis). The process according to present invention asks the user to define the basis first. After definition, the calculation program generates automatically the required input tables and the calculation algorithm depending on the selection or the selections. This allows analysis of the results dependent on the different sources of data individually and comparison of them in order to select the most suitable method within one file. Furthermore, this avoids the time-consuming generation of two different calculation files and reduces the potential for mistakes.

The user interface program then asks for definition of the targeted territory. This can be done on a very detailed country-by-country basis, for example, at later stages of the development when progressing to marketability. In the early stages of the development, however, it is very often the case that market research data are not detailed. For this reason, the territory can be defined as desired by combining countries to continents or areas and/or regions like the European Union (EU) or Latin America, South East Asia, and the like. Later, when the project progresses and additional market research data are available, the territory definitions can be adapted or modified.

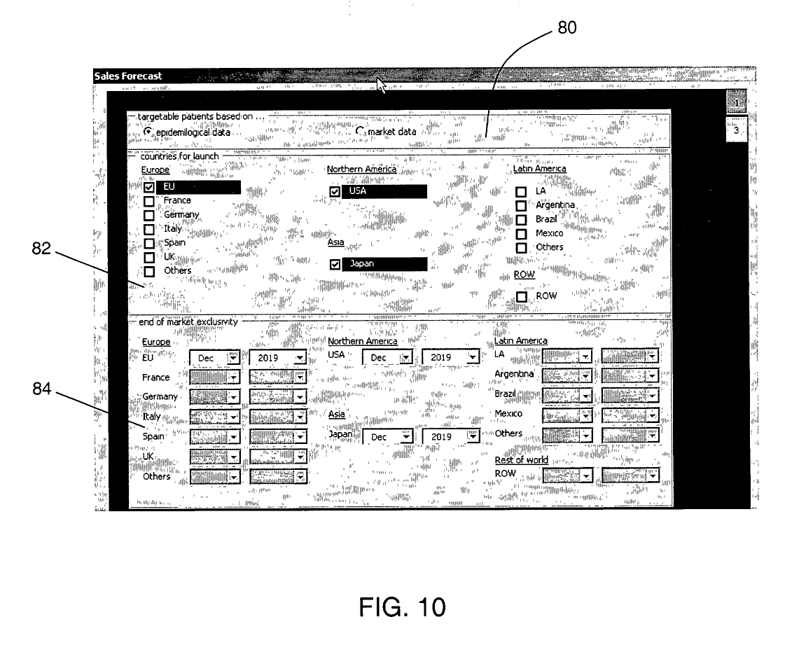

FIG. 10 is a display allowing users to selected geographical territories for which sales are to be estimated. FIG. 10 includes a first area 80 for selecting the sales estimate basis—epidemiological/patient basis or market data as discussed above. A second area 82 is provided for territory selection. A third area 84 allows users to specify patent protection details, more specifically, the estimated date for the end of market exclusivity.

This territory approach allows not only consistency of the project evaluation over the time but also integration of new information early in development. For example, it requires only a few minutes to add one or more additional countries and even less time to remove one from the calculation.

The market is next segmented step by step according to the targeted specific indication. Additional short narrative descriptions are requested and allow transparency to the approach for defining the targetable market segments chosen. Once the targetable market potential is defined—either patient based or value based —the total market as well as its sub-segments are forecasted for a specified time period. The forecast is calculated either by defining the growth rate or by individual input of numbers for each year of the consideration period.

After the specific targeted market for the project has been defined, the market environment is analyzed. Based on the information on the targeted product profile and the analysis of the present and future market environment the market success of the project is defined.

The user interface program requests the prospective launch date for each of the defined territories and for each positive-outcome scenario. Since time-to-market is a very sensitive parameter for the value of a project, it is preferred to calculate sales forecasts on a monthly basis rather than a yearly basis. This approach enables a value analyst to calculate project value dependent on time-to-launch and to demonstrate the value increase or decrease by speeding up the development or when delays occur. This is in practice a question commonly raised by the management: What are the implications of further investments to achieve earlier market entry on project value? The integrated calculation program allows easy calculation of these effects by simply changing the date of market entry. This requires only a few minutes. All other parameters including marketing investments are automatically updated due to the incorporated links.

Market success of the project can be modeled in a two step approach. First, success is defined based on the forecasting of the market until launch date including events and the competitive situation prior to launch of the project. The user interface program prompts for the input of three parameters—peak market penetration (or market share rate), time to reach peak penetration and steepness of the curve. Based on these parameters, the market entry curve is automatically modeled. This is faster than setting the rates for each year by hand. This transparent and easy approach also enables the reflection of innovative markets with usually fast penetration rates of innovative new products versus conservative markets where penetration is slow due to, for example, high brand loyalties or longterm treatment habits. Furthermore, the targeted added value of the project to the patient can be reflected in this model and thus allows adaptation of the calculation during development as more and more results become available to define the real product profile.

In a second step of modeling market success, the competitive environment is defined after launch. The user interface program prompts the user for identification of competitors and the competitors' direct implications on the project success. This is done by input of only four parameters for each competitor: launch date, influence on project peak penetration (or share) rate in percentage of project peak market penetration (or share) rate, time to reach maximal influence, and steepness of the curve. In this way, the expected competitive situation after launch and its influence on market success of the project can directly be calculated. When updating project evaluations with project progress, the development of competitive projects in the pipeline can easily and transparently be included in the calculation.

After the expected market success is defined by the above-described two step approach, the present invention calls for the calculation of the market penetration and/or share rates for the project life period. A special option for graphics enables the marketing expert to easily visualize and control the results of the modeling of project market success.

If the calculation is done on market value basis, the estimated sales are calculated directly. If the calculation is based on patient numbers, the integrated program first calculates the number of patients treated with the project for each year. For the latter approach, the price of the product is specified in order to be able to transfer the information into estimated sales. Since in the various pharmaceutical markets the basis for prices can be very different, the integrated program first asks for a calculation basis definition, for example, daily treatment costs, costs per treatment period or cycle. Then the price is set for the launch year and, in case price erosions or price increases are expected, also for the following years. Based on this information, sales forecast estimates by territory and in total are calculated. The user interface program offers to show the results in graphs for easier control and presentations.

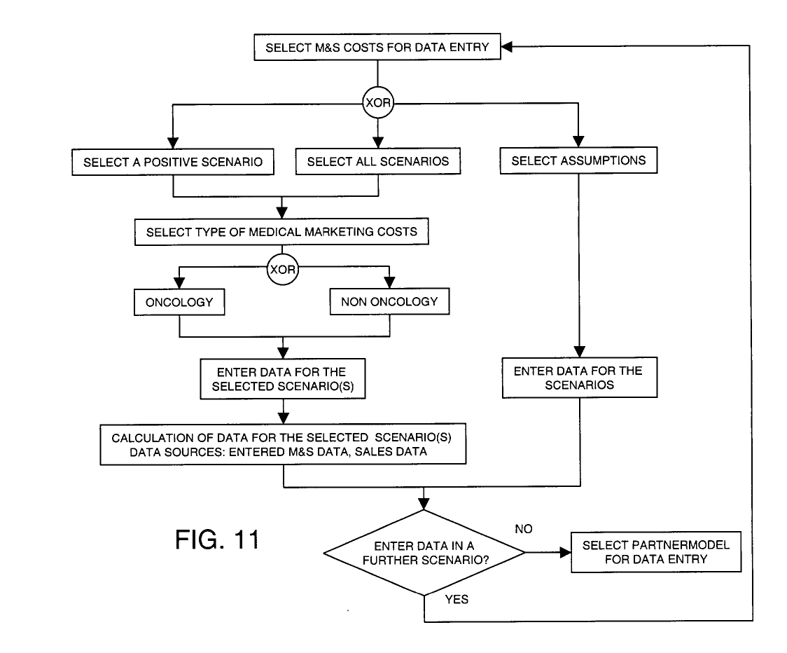

The flowchart in FIG. 11 describes an exemplary user interface sequence for entering marketing and sales-related costs. Marketing and sales (M&S) costs can vary a lot depending on the size and type of market, the competitive situation and the territory selected, not only in quantity. The choice among various marketing instruments (marketing mix) and their costs has to be selected for the individual project and thus has an influence on project value. In addition, the adequate timing of marketing investments should be considered when calculating project value. Early pre-launch (or pre-marketing) costs can influence project value substantially.

The present invention allows consideration of all these parameters in a transparent step-wise approach and thus is applicable to all pharmaceutical project evaluations. First, the expert contributor selects for which positive-outcome market scenario the M&S costs shall be developed and for which territory. Since, depending on the results of the development program, the targeted market type and estimated market success can vary, the M&S costs are directly allocated to the individual positive-outcome scenarios. Systems according to the present invention automatically link the related figures such as linking launch-date to estimated peak-sales. This is a significant advantage of the invention, because it allows fast analysis of the effect of changing single key parameters such as launch-date on project value while keeping all other parameters constant.

M&S costs are subdivided into three categories: promotion, sales force and medical marketing costs. The M&S expert contributor defines the costs of the marketing-mix planned. Similar to the approach described to estimate sales, the user interface program does not ask for absolute figures per year but asks for parameters describing the curve, namely, start of the investment in relation to the launch date, maximum investment in relation to the estimated peak sales (or in case of sales force maximum number of representatives plus costs for each representative), steepness of the curve increase and curve decrease.

The resulting M&S cost estimates are provided by category and per year. The total M&S costs are calculated in absolute figures and in relation to the estimated sales. Additional options for graphical illustration allow easy control by the user immediately after data input and thus immediate adjustment.

Many pharmaceutical development projects are in-licensed from or outlicensed to a partner; or arise out of collaborations with certain partners. In these cases, development and marketing costs are very often shared. In any given instance, the partner can substantially contribute to project value, e.g. by enlarging the sales territory covered or by contributing to the investments into development and marketing thereby sharing the project risk.

Once a contract has been signed, however, the conditions for partnering influence the internal project value to a great extent and these conditions vary from project to project. Therefore, these influences are integrated into the calculation model for estimation of the internal project value. Even if a contract has not been executed, the project value very often has to be estimated depending on the status of negotiations with a potential partner.

The present invention allows calculation of several partnering options, and thus, is a valuable tool in the hands of licensing managers for supporting their negotiations with potential partners and in the decision making process. For example, if the partner wishes to add an additional country to the license territory, the evaluation model can be readily adopted to the new scenario to see immediately the effect on project value.

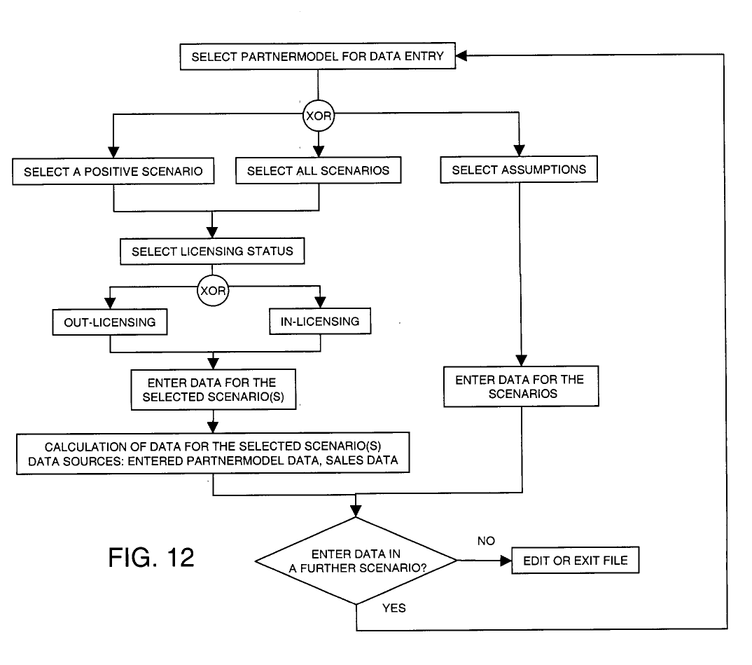

The flowchart in FIG. 12 is an exemplary user interface sequence for entering prospective and established licensing partner cost and income related estimates. For data entry, in the first step the user defines for which of the scenarios the partnering conditions are to be modeled. This enables the user to define a start for partnering and to exclude development phases, for example, to calculate the influence of the partner after having reached the “proof of concept” stage, which guarantees better conditions for the project.

Next, the category of partnering, in- or out-licensing is specified. As discussed above in reference to FIGS. 4 and 5, systems according to the present invention automatically generate the respective input tables and NPV calculation sheets. For each possible condition parameter, for example, down-payments, milestone payments, royalties, share of development and marketing costs, territory by territory input is requested by the user interface program. Based on this information, income and costs are automatically allocated in the NPV calculation sheets.

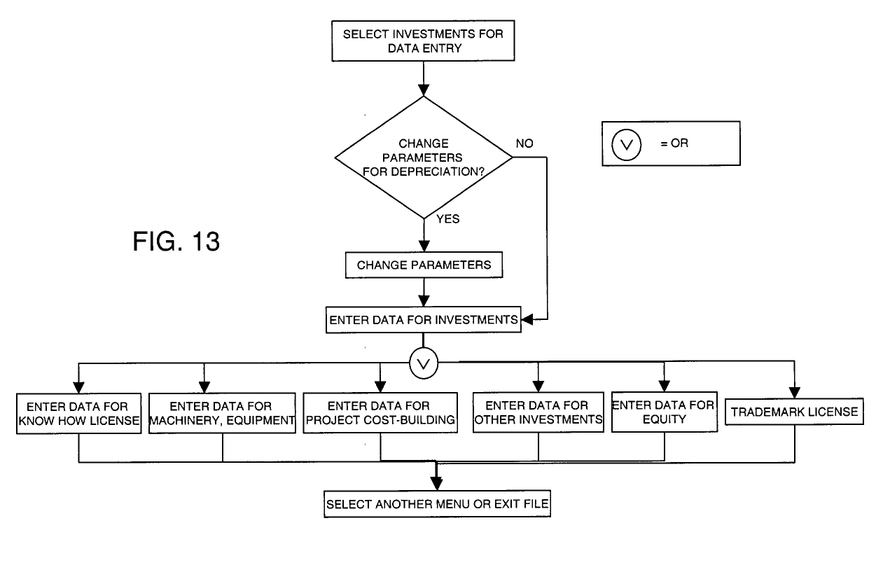

The flowchart in FIG. 13 is an exemplary user interface sequence for entering the required project investments. Investments have to be calculated in a different way than other costs. Many innovative pharma projects need substantial investments into new production facilities. In-licensing projects also may require investments into know-how, partner equity or trademarks. Such costs can have a significant effect on the value of a development project. The present invention accounts for the effect of investment costs on project value. The user interface program receives these costs in a simple table format. In addition, dependent on the internal financial rules, time for amortization or depreciation can be defined individually for all types of investments.

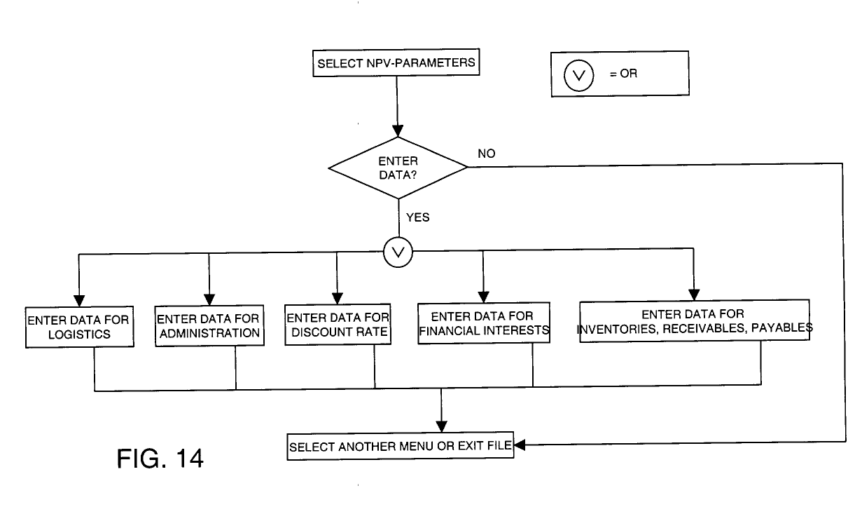

The flowchart in FIG. 14 is an exemplary user interface sequence for entering production cost estimates, operating cost estimates and financial parameters. Costs for logistics, administration overheads, discount rates or inventories as well as receivables, payables and inventories are specifiable on an individual basis and can be adapted very fast in case the controlling department redefines these parameters. The same applies to the NPV or financial parameters, such as discount rate, which are needed to calculate the project value based on cash flow earnings before income tax (EBIT) and after tax.

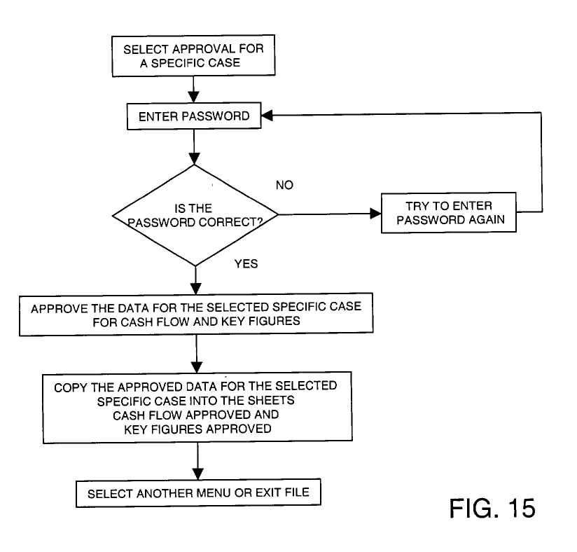

The flowchart in FIG. 15 is an exemplary user interface sequence for review and approval of data and equation inputs. Certain key data input and approved output can be secured by password-protection. This is necessary although project evaluation is a continuous process along with project development. Transparency, consistency and reliability of project evaluation cannot be guaranteed when there is no related review process. Therefore, systems according to the present invention offer to freeze the data input and output by password-protection, e.g., by portfolio managers, when the approval status is set to “approved.” In parallel, however, simulation of the effect of changes in key parameters remains possible. This enables the modeling team members to simulate the effect of interim results on the project value and to understand much better the key value drivers. Once identified, the modeling team can work on increasing project value and elaborate on further options.

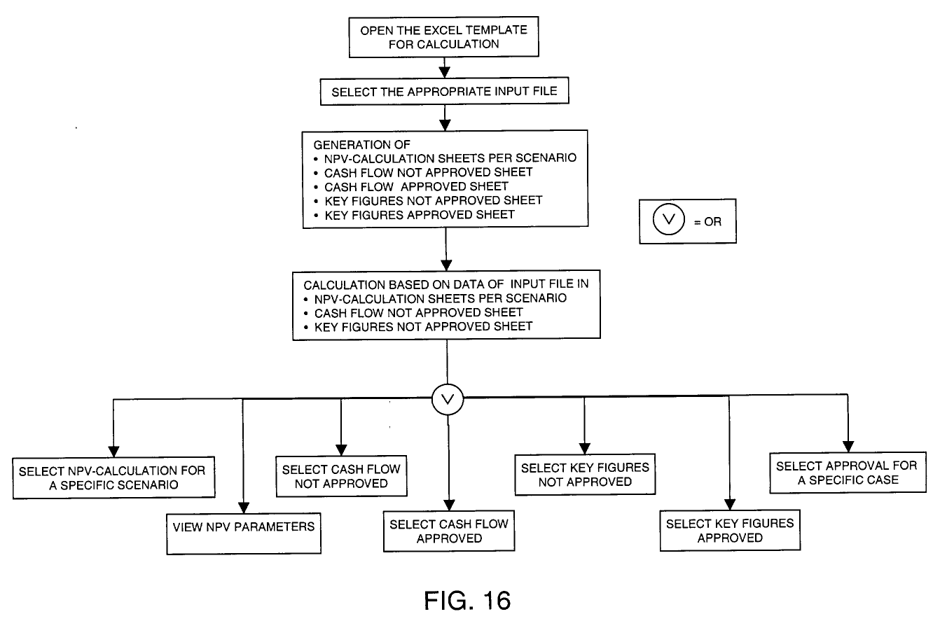

Evaluation models prepared according to a method of the present invention are available to generate a variety of calculated outputs as illustrated in FIG. 16.

For performing project evaluation using this invention, net present value (NPV) calculation and risk analysis are combined. This is possible for different kinds of business and is not limited to certain industries. Furthermore, the present invention can be applied to all types of company relevant projects such as in-house projects, acquisition projects and all kinds of licensing projects. It is not limited to certain businesses.

Project evaluation is a very complex task not only due to the integration of many experts of the project teams but also due to the high number of variables influencing project value. Many data can be generated to provide management with information for enhancing their decisions. However in practice, managers, especially upper managers, are often overloaded with a bulk of unstructured information leading to lack of understanding and identification of the key value drivers.

Data output, therefore, is preferably structured and channeled to the dedicated management level in a transparent and consistent management information system. The data output provided by the present invention for team-based project evaluations was developed based on this objective. Different categories—from general key figures to special key figures for R&D, marketing and partnering—allow detailed, but comprehensive overview about the results of the project evaluation. Furthermore for planning issues, it is important to provide probability adjusted cash-flow parameters as well as unadjusted results. Both can be shown by the invention. It is one of the key advantages of the invention that each user—those providing input on an expert level and those making decisions—can have a comprehensive overview on the project value and its drivers.

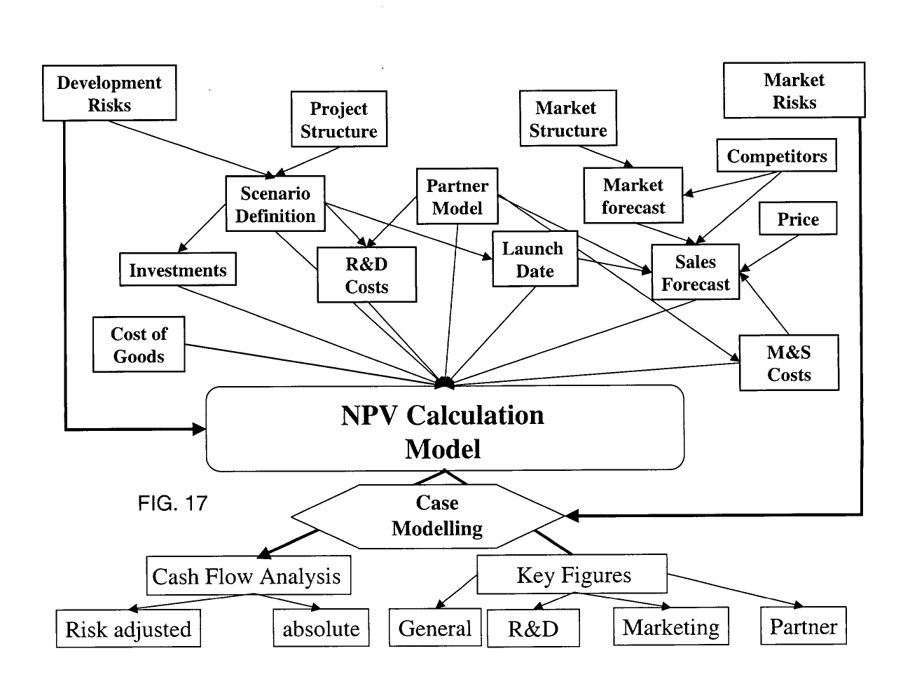

The computer-assisted evaluation methods and systems according to the present invention have a number of key features. FIG. 17 is a block diagram illustrating a number of key features of the project evaluation method. The methods and systems of the present invention are compatible with the use of decision tree analysis for structuring the possible outcomes of product development. A thorough decision tree analysis includes the enumeration of all possible intervening as well as final consequential outcomes. For each possible outcome of the development plan a respective probability is assigned (see FIG. 2).

Calculation worksheets for R&D costs, marketing costs and partner data as well as NPV financial parameters are automatically generated to simplify the modeling process. This is one of the key advantages of the present invention, since, depending on the complexity of the project decision trees, this task usually and without having the inventive tool of this process at hand, requires several hours of work for a specialized portfolio manager. In practice, even in the hands of non-portfolio specialists, worksheet generation becomes an easy task and avoids mistakes when creating the numerous spreadsheet (e.g., Excel® spreadsheet) links between scenario definition and other data like R&D costs, sales estimates and marketing investments, as well as their respective allocation to the different scenarios.

Evaluation systems according to the present invention ask for the R&D costs once, i.e., for the positive scenario. A special input table worksheet, automatically built upon the structure of the project, asks for costs allocated to the phases of the decision tree. Based upon this information and on the timing given in the scenario definition, all R&D costs are automatically aligned to the corresponding negative-outcome scenarios. In case more than one positive-outcome scenario was defined, the task can be repeated in order to guarantee adequate alignment of all R&D costs to the respective end scenarios. Due to the automatic allocation of the costs to the scenarios, data entry becomes much easier, is quicker and avoids mistakes.

Beside the well coordinated process that allows the comparison of all projects relatively to each other by using the same electronic network and calculation parameters, time-savings is another key advantage over the traditional methods known so far.

Another key feature of the present invention is model modularity. Different areas for model data entry are clearly separated in different worksheets so that the experts entering data can concentrate on their respective data input separately. Experts from different departments or working groups, e.g. R&D and marketing, can independently feed the calculation program with specific data. This permits relatively easy delegation of responsibilities to the involved project team members. The integrated program is designed for team-based project evaluations.

Through its ease of use, the present invention can create understanding and identification with the project evaluation methodology and thus enhance reliable and consistent project value assessments. Furthermore, management—especially on lower levels—can have direct access to the calculation models and control the quality of the project evaluation already at early stages and guide their co-workers if necessary. This improves transparency and credibility of the project evaluation process. It also helps to prevent duplication of work by improving quality before management presentations are made. Properly used this can improve the motivation of the teams and helps to speed up decision making.

For the skilled artisan it is evident that the method, the process and the calculation system of the present invention, as well as all other embodiments thereof, have many applications, and that the present invention is not limited to the representative examples disclosed herein. Moreover, the scope of the present invention covers variations and modifications of the system components and process components described herein as recognized by those skilled in the art.

We claim:

1. A computer-assisted method for evaluating a development project, the method comprising the steps of:
interactively defining a plurality of development scenario models;
interactively assigning a probability to each of said plurality of development scenario models;
calculating a net present value for each of said development scenario models to produce a plurality of corresponding net present values; and
processing said probabilities and said net present values to calculate a probability-weighted net present value for the development project.

2. The method according to claim 1 wherein the step of interactively defining a plurality of development scenario models includes specifying an activity category.

3. The method according to claim 2 wherein specifying an activity category includes specifying research cost estimates.

4. The method according to claim 2 wherein specifying an activity category includes specifying predicted sales.

5. The method according to claim 1 wherein the step of interactively defining a plurality of development scenario models includes modeling cost-generating activities and income-generating activities.

6. The method according to claim 1 wherein the step of interactively defining a plurality of development scenario models includes associating a previously specified activity category with a development scenario model.

7. The method according to claim 1 wherein said step of defining a plurality of development scenario models includes providing multi-user access to a development scenario model over a computer network.

8. The method according to claim 1 further comprising the step of logging an identity of data providers for a data entry to a development scenario model.

9. The method according to claim 1 further comprising the step of logging an entry time for a data entry to a development scenario model.

10. A software program including code segments to perform method steps for evaluating a development project, the method steps comprising:
interactively defining a plurality of development scenario models;
interactively assigning a probability to each of said plurality of development scenario models to produce a plurality of corresponding probabilities;
calculating a net present value for each of said development scenario models to produce a plurality of corresponding net present values; and
processing said plurality of probabilities and said plurality of net present values to calculate a probability-weighted net present value for the development project.

11. A computer-assisted method for evaluating a development project that comprises:
modeling financially a plurality of development scenarios;
assigning a probability to each of said development scenarios;
calculating a net present value for each of said scenarios;
calculating a probability weighted average present value for the project based on said net present values and said probabilities.

12. A method for computer-assisted modeling financially a development project incorporating information from different contributors, the method comprising:
defining a financial model for the development project as a plurality of activity categories;
generating a set of required inputs for each of at least two activity categories;
providing access to said sets of required inputs over a computer network;
receiving information according to one of said sets of required inputs from a first contributor; and
receiving information according to another of said sets of required inputs from a second contributor.

13. The method according to claim 12 wherein the steps of receiving information each include recording an identity indicator for said contributor.

14. The method according to claim 12 wherein the steps of receiving information each include recording an information data entry time.

15. The method according to claim 12 wherein one of the activity categories is a sales forecast and a set of required inputs for said sales forecast is provided from a contributor having sales experience.

16. The method according to claim 12 wherein said computer network is the Internet.

17. The method according to claim 12 wherein said computer network is a company intranet.

18. The method according to claim 12 wherein said step of generating a set of required inputs includes generating a spreadsheet input table.
